(19) United States
(12) Patent Application Publication
(10) Pub. No.: US 2025/0315237 A1
(43) Pub. Date: Oct. 9, 2025

(54) INTELLIGENT HARDWARE DEFINED DEPLOYMENT

(71) Applicant: International Business Machines Corporation, Armonk, NY (US)

(72) Inventors: Peng Hui Jiang, Beijing (CN); YONG QUAN TIAN, Beijing (CN); Ran Ren, Beijing (CN); Shi Peng Li, Beijing (CN); Wei Jiang, Beijing (CN); Xiao Tong Chi, Beijing (CN); Dan Qing Huang, HuiLongGuan Town (CN); Jin Fang Yang, Beijing (CN)

(21) Appl. No.: 18/625,425

(22) Filed: Apr. 3, 2024

(51) Int. Cl. G06F 8/65

(52) U.S. Cl. CPC G06F 8/65

(57) ABSTRACT

A processor set to facilitate hardware defined deployment identifies hardware components of a hardware infrastructure of a computer node. Attributes are identified associated with each of the hardware components. Relationships are constructed between the hardware components and software release bundles based on the attributes. Compatibility is determined between the software release bundles and the hardware components using the relationships. A software release bundle for deployment on the computer node is selected among the software release bundles. Deployment of the software release bundle on the computer node is monitored. Updates are made to the relationships between the software release bundle and the hardware components based on results of the deployment.

### BACKGROUND

The present application relates generally to computers and computer applications, and more particularly to computer system environment and computer component deployments.

### BRIEF SUMMARY

The summary of the disclosure is given to aid understanding of a computer system and method of hardware defined deployment, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

In some embodiments, a computer-implemented method includes identifying, by a processor set, hardware components of a hardware infrastructure of a computer node. The computer-implemented method also includes identifying, by the processor set, attributes associated with each of the hardware components. The computer-implemented method also includes constructing, by the processor set, relationships between the hardware components and software release bundles based on the attributes. The computer-implemented method also includes determining, by the processor set, compatibility of the software release bundles with the hardware components using the relationships. The computer-implemented method also includes selecting, by the processor set, among the software release bundles, and based on a predefined criterion, a software release bundle for deployment on the computer node. The computer-implemented method also includes monitoring, by the processor set, deployment of the software release bundle on the computer node. The computer-implemented method also includes updating, by the processor set, the relationships between the software release bundle and the hardware components based on results of the deployment.

In some embodiments, a computer system includes a processor set. The computer system also includes a set of one or more computer-readable storage media. The computer system also includes program instructions, collectively stored in the set of one or more computer-readable storage media, for causing the processor set to perform the following computer operations: identify hardware components of a hardware infrastructure of a computer node; identify attributes associated with each of the hardware components; construct relationships between the hardware components and software release bundles based on the attributes; determine compatibility of the software release bundles with the hardware components using the relationships; select among the software release bundles, and based on a predefined criterion, a software release bundle for deployment on the computer node; monitor deployment of the software release bundle on the computer node; and update the relationships between the software release bundle and the hardware components based on results of the deployment.

In some embodiments, a computer program product comprising a set of one or more computer-readable storage media, and program instructions, collectively stored in the set of one or more storage media, for causing a processor set to perform computer operations that perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement intelligent hardware defined deployment in some embodiments.

FIG. 2 is a diagram illustrating system architecture for operation of hardware defined deployment in some embodiments.

FIG. 3 is a diagram illustrating a hierarchical composition in cloud ecosystem in some embodiments.

FIG. 4 shows hardware building block generation in some embodiments.

FIGS. 5A-5B illustrate attribute analyzer in some embodiments.

FIG. 6 shows dynamic relationship map builder in some embodiments.

FIG. 7 illustrates a selection rule engine in some embodiments.

FIG. 8 illustrates a deployment verifier in some embodiments.

FIG. 9 illustrates dynamic relationship map updater in some embodiments.

FIG. 10 is a flow diagram illustrating a method of hardware defined deployment in some embodiments.

### DETAILED DESCRIPTION

A system including at least one computer processor and at least one memory device coupled with the at least one computer processor is also disclosed, where the at least one computer processor is configured to perform one or more methods described above. A computer program product is also disclosed that includes a computer readable storage medium having program instructions embodied therewith, where the program instructions are readable by a device to cause the device to perform one or more methods described above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as hardware defined deployment algorithm code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

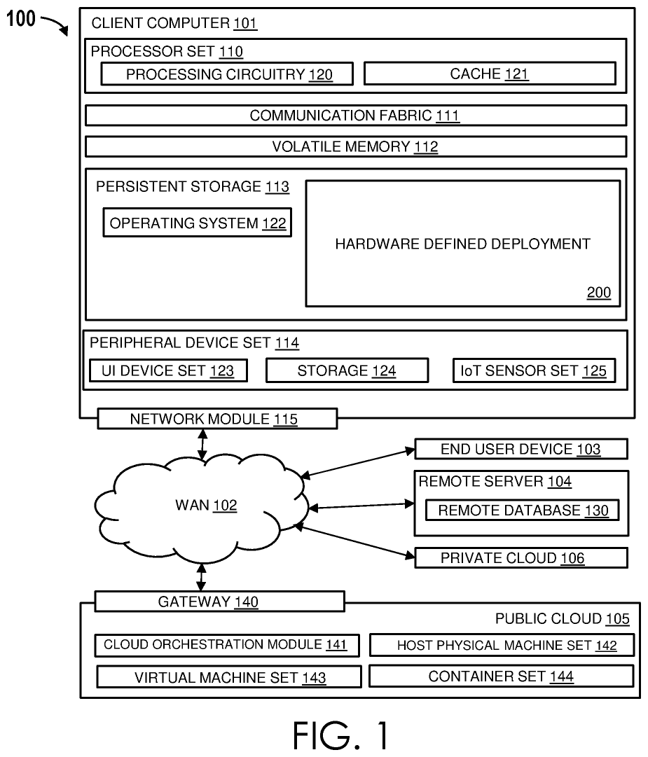

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud environments tend to have dynamic landscapes, for example, changes over time, with diverse combinations of various hardware configurations within a single cluster or across multiple clusters of computers or nodes. A computer in a cluster is also referred to as a node. A cluster includes a plurality of computers or nodes that are interconnected, interfaced, networked, or otherwise connected together. Complexity posed by such environments amplifies during deployment of software release bundles, for example, during the initial setup of a cluster and subsequent node expansions. A software release bundle includes a package of components for running on a computer for performing one or more given functions. Operators may be confronted with tasks of determining an optimal software release bundle, which decision-making process can be riddled with complexities for various reasons. Specifying software release bundles based on a static set of rules may be inadequate in the face of ever-changing hardware configurations and a plethora of software versions. This inadequacy is heightened by the absence of a systematic method to evaluate the compatibility of diverse hardware elements with varying software releases.

A cluster of computers may have varied hardware requirements. For example, different elements within a node may exhibit distinct prerequisites for software compatibility. The diverse nature of hardware components may necessitate a careful approach in selecting the appropriate software release bundle. There are also complex combinations of hardware elements. For example, the multitude of hardware elements, each with its unique specifications, results in a vast array of possible combinations. The extensive diversity makes it impractical to test all potential combinations in advance, adding an element of uncertainty to the deployment process. There are also various software versions. The availability of multiple software versions further complicates the decision-making process. Operators face the challenge of not only choosing the right software but also determining the optimal version within a given range.

In some embodiments, a system and/or method are provided for intelligent hardware defined deployment. In some embodiments, the system and/or method analyze building blocks in hardware and identify a key attribute set in those building blocks to decide the compatibility with operating system (OS) level and software release bundle. In some embodiments, the system and/or method construct dynamic relationship (e.g., relationships that change over time) between a set of building blocks and software release bundle. For example, for attributes in the set of building blocks, the system and/or method build inner relationship of attributes. For instance, the system and/or method determine the mandatory and optional characteristic, and determine the direct attribute and indirect attribute. For key attributes in the set of building blocks, the system and/or method determine a compatible software version set. In some embodiments, the system and/or method build a selection rule for a set of building blocks and compatible software release bundles. For example, a selection rule can include selecting the latest version in available version set; selecting the most stable version in available version set; and selecting the most popular version in available version set. In some embodiments, the system and/or method determine selected software release bundles for nodes in a cluster and verify their OS level compatibility and software level compatibility. In some embodiments, the system and/or method apply a deployment orchestrator to communicate with an infrastructure and orchestrate a deployment process. In some embodiments, the system and/or method update dynamic relationship map based on deployment result and adjust relationship in building block level, for example, rather than at node level.

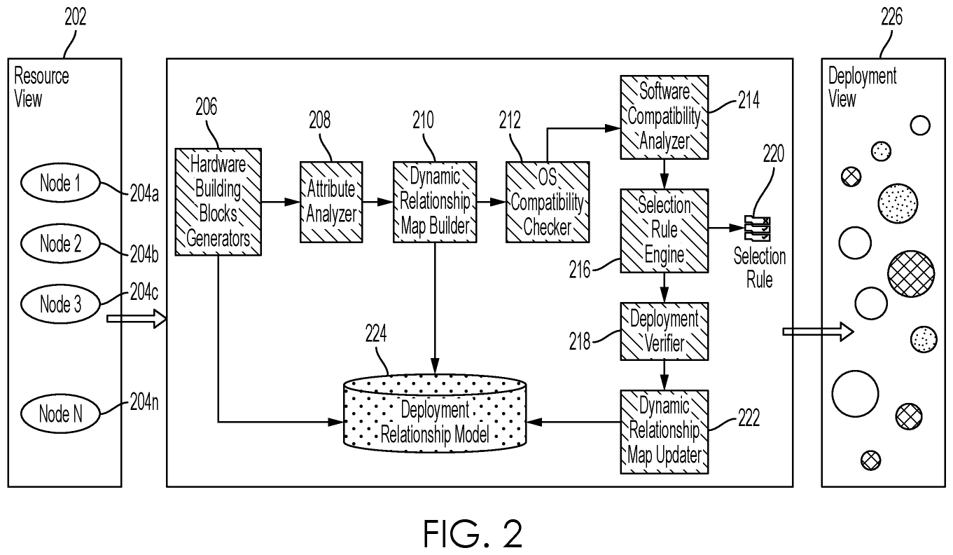

FIG. 2 is a diagram illustrating system architecture for operation of hardware defined deployment in some embodiments. Components shown can be computer-implemented components such as functions and/or modules, run on or implemented on a processor set, for example, described above with reference to FIG. 1. A computer cluster 202 can include one or more nodes 204a, 204b, 204c, 204n, which include hardware components. For example, a resource view or a view of the resources in the computer cluster 202 can be available. Hardware building blocks generator 206 analyzes building blocks in hardware, e.g., understands the components of the hardware, breaking the hardware down into building blocks. The building blocks are stored with deployment relationship model 224. Attribute analyzer 208 identifies a set of key attributes, e.g., identifies attributes that play a role in determining software compatibility. Dynamic relationship map builder 210 builds relationship between building block set and software release bundle. Relationship building is dynamic in that updates are made to relationships as components in hardware and software change, for example, in real time or substantially in real time. Dynamic relationship map builder 210 establishes a dynamic relationship that defines how the attributes of the building block set relate to different software release bundles. Relationships are stored with the deployment relationship model 224. Dynamic map stored by the deployment relationship model 224 allows for flexibility and adaptability. Operating system (OS) compatibility checker 212 evaluates compatibility of different operating system versions with hardware attributes. Software compatibility analyzer 214 analyzes software release bundles' compatibility with hardware and operating system versions. Selection rule engine 216 selects a software release bundle among software release bundles determined to be compatible by software compatibility analyzer 214, based on selection criteria or rule 220. Deployment verifier 218 validates a software release bundle selected by selection rule engine 216 for deployment. Dynamic relationship map updater 222 updates the deployment relationship model 224, for example, in real time or near real time. Block at 226 shows a deployment view showing various software release bundles (shown as circles of various sizes) deployed on compatible hardware.

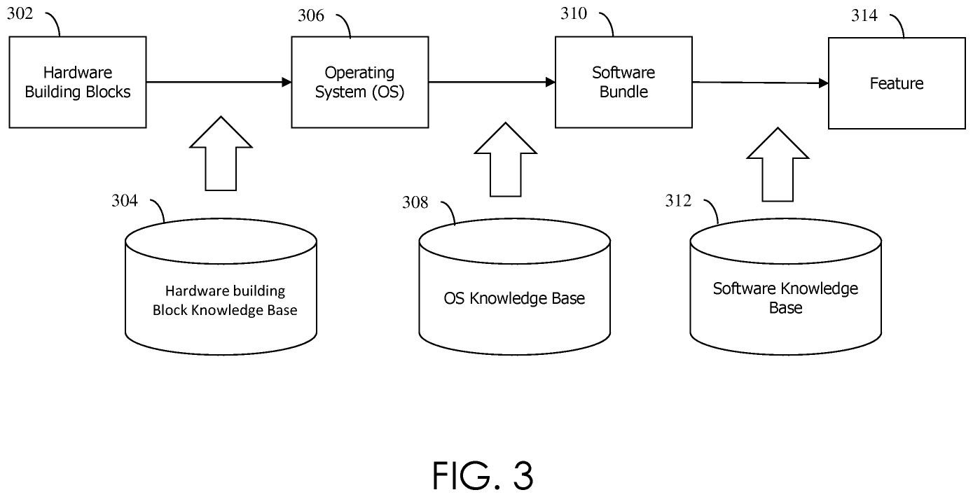

FIG. 3 is a diagram illustrating a hierarchical composition in cloud ecosystem in some embodiments. The hierarchical progression from hardware building blocks 302 to software features 314 illustrates the interconnected layers that shape the cloud environment. In some embodiments, the system and/or method construct and select through these layers for orchestrating a seamless and optimized deployment process to ensure that each component aligns harmoniously to deliver robust and tailored solutions in the ever-evolving landscape of cloud computing. Hardware building blocks can be identified at 302 and stored on a storage, database or knowledgebase, for example, referred to as hardware building block knowledgebase 304. Operating systems can be checked for versions at 306 and stored on a storage, database or knowledgebase, for example, referred to as operating system knowledgebase 308. Software bundles can be identified at 310 and stored on a storage, database or knowledgebase, for example, referred to as software knowledgebase 312. Features 314 requested by a user or customer can be provided based on software bundle that has compatibility with hardware and operating system version as determined using the downstream components (e.g., 302, 304, 306, 308, 310, 312).

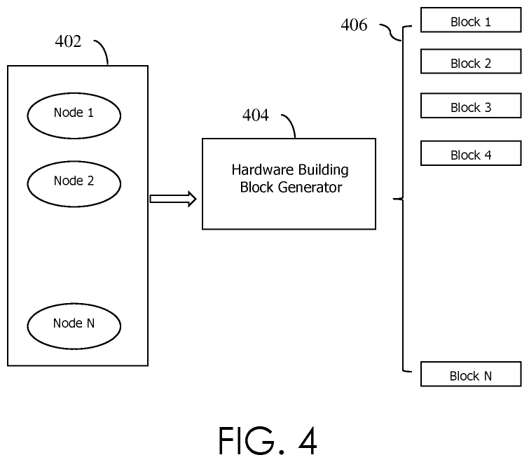

FIG. 4 shows hardware building block generation in some embodiments, for example, shown at 206 in FIG. 2. Hardware building block generation includes identifying components or subsystems (referred to as building blocks) that constitute the hardware infrastructure. Hardware building block generator 404 (also shown as 206 in FIG. 2) analyzes hardware of nodes 402 and identifies components or subsystems of those nodes. Examples of building blocks (e.g., shown at 406 as block #) include, but are not limited to, central processing unit (CPU), graphics processing unit (GPU), memory (e.g., random access memory (RAM)), storage (hard disk drive (HDD), solid state drive (SSD)), motherboard, power supply unit (PSU), cooling system, networking interface, peripheral interfaces (universal serial bus (USB), High-Definition Multimedia Interface (HDMI), etc.), chassis/case. For example, CPU is responsible for executing instructions of a computer program. GPU is a processor specialized for rendering graphics and performing parallel processing tasks. Memory (e.g., RAM) provides temporary storage for data and program code that is actively being used. Storage includes devices for permanent data storage. Motherboard connects and allows communication between various hardware components. Power Supply Unit (PSU) provides electrical power to the components of the computer. Cooling system manages the temperature of the hardware components to prevent overheating. Networking interface facilitates network communication. Peripheral interfaces connects external devices like USB ports, audio jacks, etc. Chassis/Case encloses and protects the internal hardware components. There exist different versions of each of those components, for example, manufactured by different manufacturers.

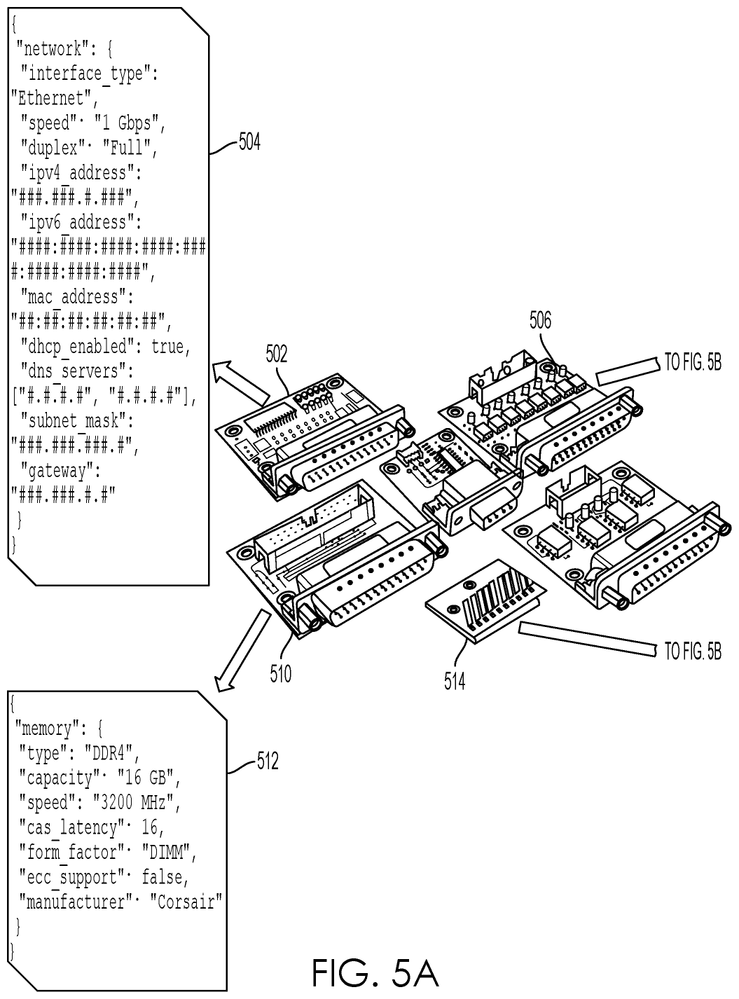

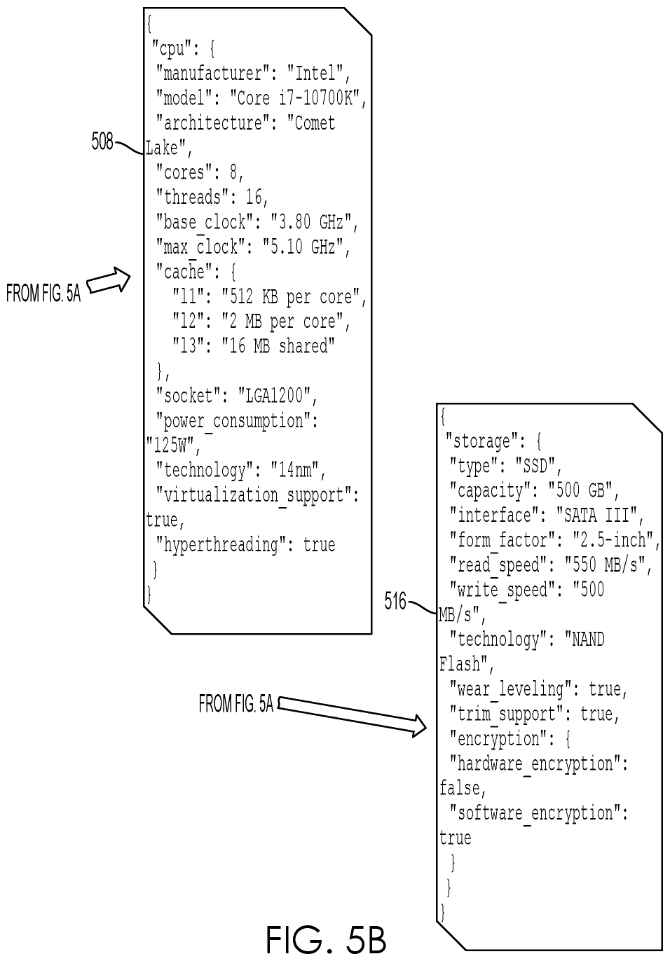

FIGS. 5A-5B illustrate attribute analyzer in some embodiments, for example, shown at 208 in FIG. 2. For each identified component, attribute analyzer (e.g., 208 in FIG. 2) defines key attributes that are relevant for intelligent deployment. Examples of attributes include, but are not limited to, model, capacity, speed, version, and other relevant specifications. Attribute analyzer understands the relationships and dependencies between different components, considering both direct and indirect relationships that may impact software compatibility and deployment decisions. Analyzing the attributes of each hardware building block identifies characteristics, such as CPU model, GPU type, memory capacity, and/or other information associated with a respective component. For example, “network interface” 502 building block is identified to have the attributes shown at 504 (in the figure “#” characters represent numerical values that appear in addresses); “CPU” 506 building block is identified to have attributes shown at 508; “memory” 510 building block is identified to have attributes shown at 512; “storage” 514 building block is identified to have attributes shown at 516.

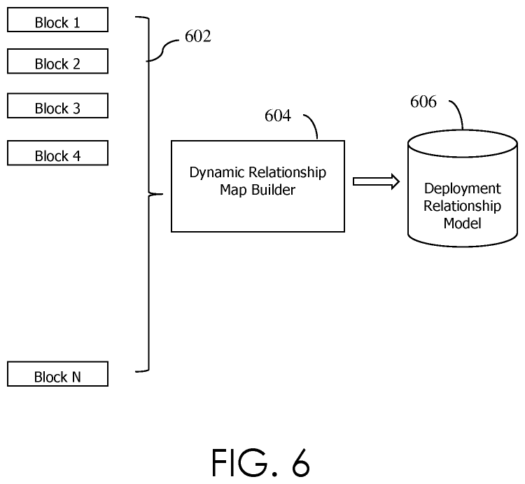

FIG. 6 shows dynamic relationship map builder in some embodiments, e.g., also shown at 210 in FIG. 2. Dynamic relationship map builder 604 dynamically constructs and updates relationships and dependencies between different hardware building blocks. Constructing and updating of relationships can be dynamic in that the relationships are made up-to-date, based on periodic or real-time updates being made to established relationships, to reflect changing configurations of components, e.g., shown as blocks 602 such as hardware components in computing environments. Updates are kept or stored in deployment relationship model 606 or data store, for example, on a storage device. Dynamic relationship map builder 604 offers a real-time reaction by leveraging adaptive mapping algorithms to illustrate how changes in one component may affect others. Dynamic relationship map builder 604 supports proactive decision-making during system modifications or upgrades by providing a comprehensive and up-to-date overview of the dynamic relationships between hardware elements.

Dynamic relationship map builder 604 defines how various attributes within hardware building blocks are interconnected. Dynamic relationship map builder 604 outlines the dependencies and influences between these attributes, providing a structured representation of how changes in one attribute may impact others. Dynamic relationship map builder 604 serves as a guide for understanding the relationships to ensure a comprehensive view of the hardware ecosystem and assisting in making informed decisions during system configurations, upgrades, or optimizations.

Dynamic relationship map builder 604 builds inner relationship or inter-relationship of attributes, e.g., understands the relationships between individual attributes within a building block. This understanding allows for determining how changes in one attribute impact other attributes. Dynamic relationship map builder 604 determines mandatory and optional characteristics, e.g., identifies which attributes are mandatory for compatibility and which ones are optional. This distinction allows for a more nuanced approach to software selection. Dynamic relationship map builder 604 determines direct and indirect attributes, e.g., understands which attributes directly influence software compatibility and which ones have an indirect impact. This distinction helps in creating a more comprehensive mapping.

Table 1 below illustrates an example of a model or database that stores components or building blocks of hardware in some embodiments. A node, for example, can be identified to have building blocks or components such as a processor, memory, storage, and network. Other components can also be identified and information about those components stored in the model. Attributes associated with those building blocks are also identified as shown in Table 1. For example, a “processor” is identified to have attributes such as “manufacturer”, “cores”, “base clock” and “architecture.” Other attributes can also be identified and stored. Table 1 describes attributes for other components. Relationships are also stored with the model, e.g., “attribute_relationships”, “storage_network_relationship”, and/or others. Other relationships can be identified and stored.

```
TABLE 1
{
  “hardware_building_block”: {
    “processor”: {
      “manufacturer”: “Intel”,
      “cores”: 8,
      “base_clock”: “3.0 GHz”,
      “architecture”: “Core i7”
    },
    “memory”: {
      “type”: “DDR4”,
      “capacity”: “16 GB”,
      “speed”: “3200 MHz”
    },
    “storage”: {
      “type”: “SSD”,
      “capacity”: “500 GB”,
      “interface”: “NVMe”
    },
    “network”: {
      “interface_type”: “Ethernet”,
      “speed”: “1 Gbps”,
      “ipv4_support”: true
    }
  },
  “attribute_relationships”: {
    “processor_memory_relationship”: {
      “dependency”: [“processor.cores”, “memory.capacity”],
      “impact”: “Direct”,
      “description”: “The number of processor cores impacts the
memory capacity requirements for optimal performance.”
    },
    “storage_network_relationship”: {
      “dependency”: [“storage.type”, “network.speed”],
      “impact”: “Indirect”,
      “description”: “The type of storage may indirectly impact
network speed based on data retrieval and transmission requirements.”
    }
  }
}
```

Operating system (OS) compatibility checker (e.g., shown at 212 in FIG. 2) evaluates the compatibility of different operating system versions with hardware attributes. It considers both direct and indirect compatibility factors. Examples of direct factors can include, but are not limited to, processor, memory. Examples of indirect considerations can include, but are not limited to, peripheral support. Table 2 shows an example model or database that stores OS compatibility information, for example, discovered or identified by the OS compatibility checker. As shown in the example, there is “compatibility” between components of hardware and OS for the first “hardware” as shown by the checkmark (“V”). For the second “hardware”, while “compatibility” exists between components of hardware, there is no compatibility with OS, e.g., as shown by “X” mark.

TABLE 2

```
{
  ″systems″: [
    {
      ″hardware″: {
        ″processor″: {″manufacturer″: ″Intel″, ″cores″: 8},
        ″memory″: {″type″: ″DDR4″, ″capacity″: ″16 GB″},
        ″storage″: {″type″: ″SSD″, ″capacity″: ″500 GB″},
        ″network″: {″interface″: ″Ethernet″, ″speed″: ″1 Gbps″}
      },
      ″os″: {″name″: ″OSv1″, ″version″: ″1.0″},
      “compatibility”: {“hardware”: true, “os”: true ✓ }
    },
    {
      ″hardware″: {
        ″processor″: {″manufacturer″: ″AMD″, ″cores″: 6},
        ″memory″: {″type″: ″DDR4″, ″capacity″: ″32 GB″},
        ″storage″: {″type″: ″HDD″, ″capacity″: ″1 TB″},
        ″network″: {″interface″: ″Wi-Fi″, ″speed″: ″300 Mbps″}
      },
      ″os″: {″name″: ″OSv2″, ″version″: ″2.0″},
      “compatibility”: {“hardware”: true, “os”: false X}
    }
]
}
```

Software compatibility analyzer (e.g., shown at 214 in FIG. 2) analyzes software release bundles' compatibility with hardware and operating system versions. Software compatibility analyzer determines which software bundles are compatible and provides this information as output. Software compatibility analyzer delves into version ranges and dependencies to provide a comprehensive evaluation of compatibility within the computing environment. For example, for attributes, compatible software version set can be determined. Software compatibility analyzer defines a set of software versions that are compatible with each attribute or key attribute that is identified for building blocks. For example, version-specific features and hardware requirements are considered for determining compatibility. Table 3 shows an example model that stores example results determined based on software compatibility analysis, e.g., by the software compatibility analyzer. As shown, by way of example, “SoftwareA” is determined to be compatible with hardware and operating system versions, while “SoftwareB” is not.

```
TABLE 3
{
  ″systems″: [
    {
      ″hardware″: {
        ″processor″: {″manufacturer″: ″Intel″, ″cores″: 8},
        ″memory″: {″type″: ″DDR4″, ″capacity″: ″16 GB″},
        ″storage″: {″type″: ″SSD″, ″capacity″: ″500 GB″},
        ″network″: {″interface″: ″Ethernet″, ″speed″: ″1 Gbps″}
      },
      ″os″: {″name″: ″OSv1″, ″version″: ″1.0″},
      ″software″: {
        ″name″: ″SoftwareA″,
        ″version_range″: ″v1.0-2.0″,
        ″features″: [″Feature1″, ″Feature2″]
      },
      “compatibility”: {“hardware”: true, “os”: true, “software”: true ✓ }
    },
    {
      ″hardware″: {
        ″processor″: {″manufacturer″: ″AMD″, ″cores″: 6},
        ″memory″: {″type″: ″DDR4″, ″capacity″: ″32 GB″},
        ″storage″: {″type″: ″HDD″, ″capacity″: ″1 TB″},
        ″network″: {″interface″: ″Wi-Fi″, ″speed″: ″300 Mbps″}
      },
      ″os″: {″name″: ″OSv2″, ″version″: ″2.0″},
      ″software″: {
        ″name″: ″SoftwareB″,
        ″version_range″: ″v2.0-3.0″,
        ″features″: [″Feature2″, ″Feature3″]
      },
      “compatibility”: {“hardware”: true, “os”: false X, “software”:
      false X }
    }
]
}
```

Data structure shown in Tables 1, 2 and 3 above can be stored as a model (e.g., a data structure), e.g., as a deployment relationship model (shown at 224 in FIG. 2).

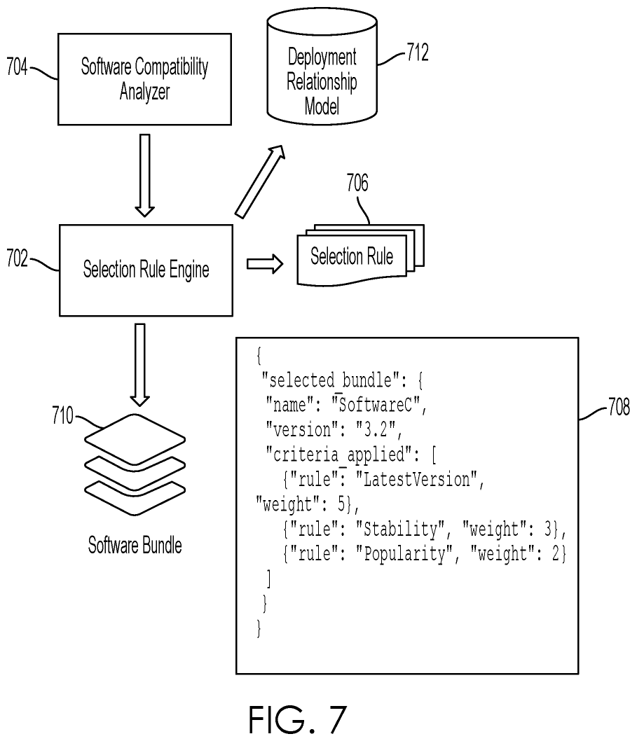

FIG. 7 illustrates a selection rule engine in some embodiments. Selection rule engine 702 (e.g., also shown at 216 in FIG. 2) takes software bundles' compatibility with hardware and operating system, e.g., output generated from the software compatibility analyzer 704 described above, and applies predefined rules or criteria 706 to determine which software release bundle should be selected for deployment on which hardware. Selection rule engine 702 generates output 708 to specify the selected software bundle 710 based on the predefined rules 706. Selection rules can be built for building blocks and compatible software release bundles. Rules can be developed that guide the selection of software release bundles based on the attributes of the building blocks. This may include rules for selecting the latest, most stable, or most popular versions. For example, rules can be defined or predefined for selecting the most appropriate software release bundles based on hardware attributes, OS compatibility, and other factors. Implementing or use of selection rules to choose the appropriate software version based on one or more criteria ensures that deployment aligns with specific priorities. Examples of rules include, but are not limited to, selecting the latest version in available version set; selecting the most stable version in available version set; and selecting the most popular version in available version set. Stability of versions can be determined based on historical data. Similarly, popularity of versions can be determined based on information available about the versions. Established rules can be applied to determine or select software release bundles for nodes in a cluster. Selection rule engine 702 updates deployment relationship model 712 with its output 708.

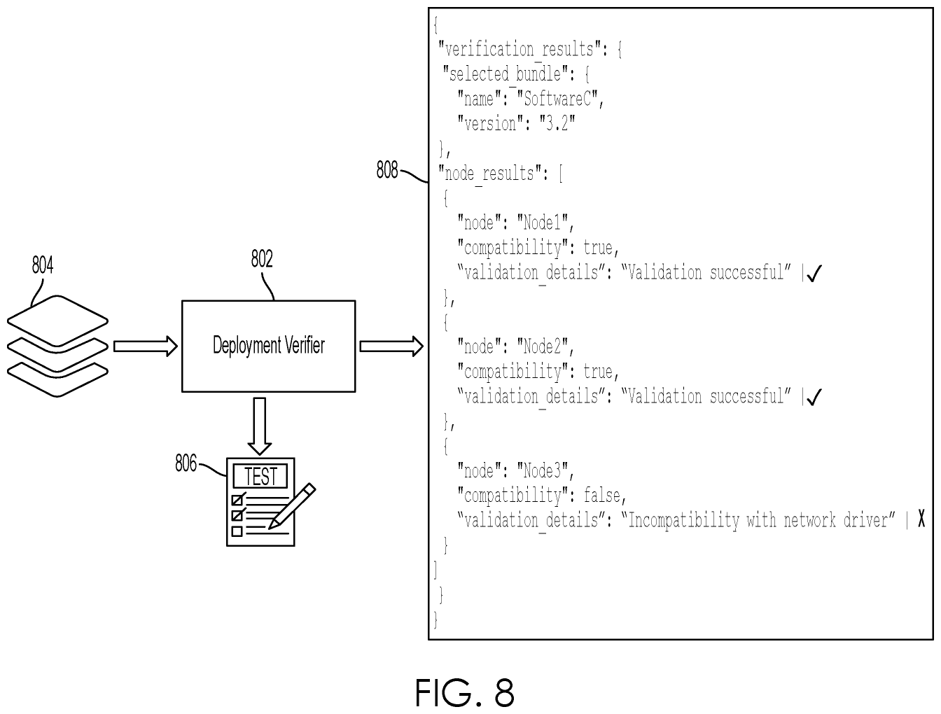

FIG. 8 illustrates a deployment verifier in some embodiments. Deployment verifier 802 (also shown at 218 in FIG. 2) takes a selected software release bundle 804, e.g., an output from the selection rule engine as input, and verifies the selected software release bundle 804 for each node in a cluster to ensure compatibility for a smooth deployment process. Deployment verifier 802 conducts validation and testing procedures 806 to confirm that the selected software release bundle 804 is suitable for deployment. Validation results generated and output by deployment verifier 802 can be stored in a database or model.

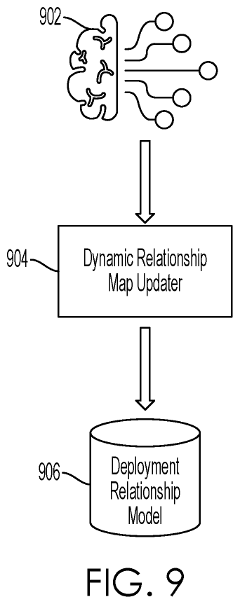

FIG. 9 illustrates dynamic relationship map updater in some embodiments. Deployment orchestrator 902 orchestrates a deployment process based on the made decisions, for example, to deploy a selected software release bundle that has be validated for deploying to a computing environment. Deployment orchestrator 902 communicates with the infrastructure to initiate deployment processes. Deployment orchestrator 902 oversees software installation and configuration management. Deployment orchestrator 902 coordinates with a deployment verifier (e.g., 802 in FIG. 8) for compatibility verification. Deployment orchestrator 902 handles error scenarios and implements a rollback mechanism if needed. Deployment orchestrator 902 monitors the progress of the deployment.

Dynamic relationship map updater 904 dynamically updates the deployment relationship model 906 or map based on real-time deployment results, ensuring it remains a reliable reflection of the evolving hardware and software landscape. Operating at the hardware building block level, the dynamic relationship map updater 904 adjusts relationships to capture intricate dependencies that may emerge during deployment. This adaptive mechanism enables the deployment relationship model 906 to align with the current state of the system, offering system administrators an up-to-date visual representation of the dynamic relationships between hardware components and software elements. Dynamic relationship map updater 904 enhances the deployment relationship model's 906 relevance, providing valuable insights into the evolving dynamics of the computing environment.

For example, dynamic relationship map can be updated based on a deployment result. Dynamic relationship map updater 904 analyzes the results of the deployment and updates the dynamic relationship map (e.g., also referred to as deployment relationship model shown at 224 in FIG. 2). Dynamic updates to the dynamic relationship map allows for continuous improvement and adaptation to changing hardware and software landscapes. In some embodiments, relationships stored in dynamic relationship map can be adjusted at the building block level, not only at the node level or rather than at the node level. For example, in some embodiments, instead of adjusting relationships at the node level, focus can be placed on the building block level. This relationship adjustment at the building block level allows for a more granular and efficient adjustment process.

Different generations of hardware can require different OS versions or levels run on them, further requiring different software versions that run on top of those OS versions. The system and/or method disclosed herein can select and oversee deployment of software release bundles such that software deployed on computing environments are compatible with computing environments' hardware and operating systems. By intelligently analyzing hardware attributes and software compatibility, the system and/or method ensure that deployments are finely tuned for optimal performance, minimizing compatibility issues. Dynamic relationship map (also referred to as a deployment relationship model, e.g., shown at 224 in FIG. 2) allows for better understanding of hardware dependencies, facilitating efficient resource allocation and preventing overutilization of specific components. A rule-based selection engine empowers administrators to make adaptive decisions, selecting software bundles based on defined criteria, ensuring alignment with hardware and operating system configurations. Dynamic relationship map (also referred to as a deployment relationship model, e.g., shown at 224 in FIG. 2), which is updated by a relationship map updater (also referred to as a dynamic relationship map updater shown at 222 in FIG. 2), provides real-time insights into hardware and software dynamics, aiding administrators in making informed decisions for ongoing system maintenance and optimization.

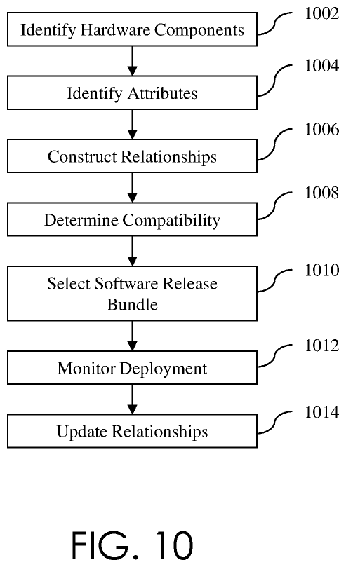

FIG. 10 is a flow diagram illustrating a method of hardware defined deployment in some embodiments. The method can be performed by a processor set, for example, as described above with reference to FIG. 1. At 1002, the method includes identifying hardware components of a hardware infrastructure of a computer node. For example, as described above, and also with reference to FIG. 4, hardware components and/or subsystems such as processors (e.g., CPU, GPU), memory (e.g., RAM), storage (e.g., HDD, SSD), network interface (e.g., HDMI), and/or other components are identified in a computer node.

At 1004, the method includes identifying attributes associated with each of the hardware components. For example, as described above, and also with reference to FIGS. 5A-5B, attributes of the hardware components, such as model type, version, capacity, speed, and/or other attributes (e.g., those affecting deployment) can be identified. In some embodiments, the relationships are constructed based on the inter-relationships of the attributes. In some embodiments, the inter-relationships include mandatory and optional characteristics among the attributes. In some embodiments, the inter-relationships include direct dependencies among attributes. In some embodiments, the inter-relationships include indirect dependencies among attributes.

At 1006, the method includes constructing relationships between the hardware components and software release bundles based on the attributes. For example, as described above, and also with reference to FIG. 6, a relationship map can be built that defines interconnections of various attributes within the hardware infrastructure, e.g., between individual attributes identified at 1004 and individual hard components identified at 1002. The relationship map is dynamic as the map can be changed over time, e.g., based on events occurring in the computer node.

At 1008, the method includes determining, by the processor set, compatibility of the software release bundles with the hardware components using the relationships. For example, as described above, and also with reference to the software compatibility analyzer shown in FIG. 2, compatibility between individual hardware component attributes (e.g., version ranges and dependencies of hardware components) and software components in the software release bundles can be checked, for example, based on specifications, prior validations, and/or tests that are available of software release bundles. In some embodiments, as described above, determining compatibility also includes checking for operating system compatibility with the software release bundles and updating the relationships based on the checking.

At 1010, the method includes selecting among the software release bundles, and based on a predefined criterion, a software release bundle for deployment on the computer node. For example, as described above, and also with reference to FIG. 7, criterion such as recency of version (e.g., latest version), stability, and popularity, can be used for selecting a software release bundle from a set of software release bundles determined to be compatibility with the hardware infrastructure.

At 1012, the method includes monitoring deployment of the software release bundle on the computer node. For instance, as described above, an orchestrator functionality of the processor set running the method may initiate a deployment process of installing and configuring the software release bundle on the computer node, and monitor the deployment process. In some embodiments, monitoring the deployment process includes tracking the progress, status, and health of the software release bundle installation and configuration on the computer node. The result of monitoring is used to adjust the relationships (e.g. information in the deployment relationship model, e.g., shown in FIG. 2 at 224) and re-build deployment.

At 1014, the method includes updating the relationships between the software release bundle and the hardware components based on results of the deployment. For example, updating the relationships includes adjusting configurations, dependencies, and mappings to ensure the computer node functions correctly. For example, changes in service availability, configuration settings, hardware dependencies, or computer node's health status during deployment can affect relationships calling for updates.

In some embodiment, for example, as described above and with reference to FIG. 8, the software release bundle goes through a verification process, in which the software release bundle is validated and tested for deployment. For example, before initiating the deployment of the software release bundle, the processor set may verify the software release bundle for compatibility by conducting validation and testing procedures to confirm suitability of the software release bundle for deployment on the computer node. By way of example, before deploying a software release bundle, validation and testing procedures may include compatibility testing, dependency verification, functional and performance testing, security assessments, regression testing, user acceptance testing, and automated testing.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in some embodiments” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
identifying, by a processor set, hardware components of a hardware infrastructure of a computer node;
identifying, by the processor set, attributes associated with each of the hardware components;
constructing, by the processor set, relationships between the hardware components and software release bundles based on the attributes;
determining, by the processor set, compatibility of the software release bundles with the hardware components using the relationships;
selecting, by the processor set, among the software release bundles, and based on a predefined criterion, a software release bundle for deployment on the computer node;
monitoring, by the processor set, deployment of the software release bundle on the computer node; and
updating, by the processor set, the relationships between the software release bundle and the hardware components based on results of the deployment.

2. The computer-implemented method of claim 1, further including verifying the software release bundle before initiating the deployment of the software release bundle for compatibility by conducting validation and testing procedures to confirm suitability of the software release bundle for deployment on the computer node.

3. The computer-implemented method of claim 1, wherein the constructing of the relationships between the hardware components and the software release bundles based on the attributes includes building inter-relationships of the attributes, wherein the relationships are constructed based on the inter-relationships of the attributes.

4. The computer-implemented method of claim 1, wherein the inter-relationships include mandatory and optional characteristics among the attributes.

5. The computer-implemented method of claim 1, wherein the inter-relationships include direct dependencies among attributes.

6. The computer-implemented method of claim 1, wherein the inter-relationships include indirect dependencies among attributes.

7. The computer-implemented method of claim 1, further including checking for operating system compatibility with the software release bundles and updating the relationships based on the checking.

8. A computer program product comprising:
a set of one or more computer-readable storage media;
program instructions, collectively stored in the set of one or more storage media, for causing a processor set to perform the following computer operations:
identify hardware components of a hardware infrastructure of a computer node;
identify attributes associated with each of the hardware components;
construct relationships between the hardware components and software release bundles based on the attributes;
determine compatibility of the software release bundles with the hardware components using the relationships;
select among the software release bundles, and based on a predefined criterion, a software release bundle for deployment on the computer node;
monitor deployment of the software release bundle on the computer node; and
update the relationships between the software release bundle and the hardware components based on results of the deployment.

9. The computer program product of claim 8, wherein the computer operations further include verifying the software release bundle before initiating the deployment of the software release bundle for compatibility by conducting validation and testing procedures to confirm suitability of the software release bundle for deployment on the computer node.

10. The computer program product of claim 8, wherein the relationships are constructed between the hardware components and the software release bundles based on the attributes by building inter-relationships of the attributes, wherein the relationships are constructed based on the inter-relationships of the attributes.

11. The computer program product of claim 10, wherein the inter-relationships include mandatory and optional characteristics among the attributes.

12. The computer program product of claim 10, wherein the inter-relationships include direct dependencies among attributes.

13. The computer program product of claim 10, wherein the inter-relationships include indirect dependencies among attributes.

14. The computer program product of claim 8, wherein the computer operations further includes checking for operating system compatibility with the software release bundles and updating the relationships based on the checking.

15. A computer system comprising:
a processor set;
a set of one or more computer-readable storage media;
program instructions, collectively stored in the set of one or more computer-readable storage media, for causing the processor set to perform the following computer operations:
identify hardware components of a hardware infrastructure of a computer node;
identify attributes associated with each of the hardware components;
construct relationships between the hardware components and software release bundles based on the attributes;
determine compatibility of the software release bundles with the hardware components using the relationships;
select among the software release bundles, and based on a predefined criterion, a software release bundle for deployment on the computer node;
monitor deployment of the software release bundle on the computer node; and
update the relationships between the software release bundle and the hardware components based on results of the deployment.

16. The computer system of claim 15, wherein the computer operations further include verifying the software release bundle before initiating the deployment of the software release bundle for compatibility by conducting validation and testing procedures to confirm suitability of the software release bundle for deployment on the computer node.

17. The computer system of claim 15, wherein the relationships are constructed between the hardware components and the software release bundles based on the attributes by building inter-relationships of the attributes, wherein the relationships are constructed based on the inter-relationships of the attributes.

18. The computer system of claim 16, wherein the inter-relationships include mandatory and optional characteristics among the attributes.

19. The computer system of claim 16, wherein the inter-relationships include direct dependencies among attributes.

20. The computer system of claim 15, wherein the inter-relationships include indirect dependencies among attributes.
